(19) United States
(12) Patent Application Publication
(10) Pub. No.: US 2022/0210605 A1
(43) Pub. Date: Jun. 30, 2022

(54) SYSTEMS AND METHODS FOR ASSISTING DRIVERS AND RIDERS TO LOCATE EACH OTHER

(71) Applicant: Robert Bosch GmbH, Stuttgart (DE)

(72) Inventors: Sirajum MUNIR, Pittsburgh, PA (US); Vivek JAIN, Sunnyvale, CA (US); Samarjit DAS, Sewickley, PA (US)

(21) Appl. No.: 17/135,290

(22) Filed: Dec. 28, 2020

(51) Int. Cl. H04W 4/02; H04W 4/029; G06K 9/00; H04B 7/06; G06Q 10/02

(52) U.S. Cl. CPC H04W 4/023; H04W 4/029; G06Q 10/02; G06K 9/00791; H04B 7/0626; G06K 9/00369

(57) ABSTRACT

A system for assisting drivers and riders to find each other in a ride-hailing service is provided. A driver device may communicate with a rider device. The driver device may receive GPS coordinates of the rider device such that the relative location of the rider device can be determined via GPS. In response to the rider device being within a threshold distance from driver device, the rider device and driver device can connect via Wi-Fi to share data to improve the locational ability of the system. At least one processor can receive Wi-Fi data packets from the rider device, measure and extract channel state information (CSI) from the Wi-Fi data packets, execute an angle of arrival (AoA) application to determine the angle of arrival based on the CSI, and display a location of the rider based on the determined angle of arrival from the CSI.

### TECHNICAL FIELD

The present disclosure relates to systems and methods for assisting drivers and riders to locate each other.

### BACKGROUND

Ride-hailing services have been increasing in popularity for years. These services allow a rider to hail a driver through an application on both the rider's mobile device and the driver's mobile device. Current ride-hailing applications rely on global positioning system (GPS) signals to help drivers to locate the riders, and vice versa. This can be difficult in places like downtown urban areas where large buildings can block or interfere with the GPS signals, in places where drivers need to come indoors to pick up the rider, or in crowded places like airports, stadiums and theaters.

### SUMMARY

According to an embodiment, a system for assisting drivers and riders to find each other includes a user interface; a storage configured to maintain an angle of arrival (AoA) application that, when executed, determines an angle of arrival of an incoming Wi-Fi signal; and at least one processor in communication with the user interface and the storage, the at least one processor. The at least one processor is programmed to receive a location of a rider's mobile device via GPS, and perform the following steps in response to the location of the rider's mobile device being within a threshold distance from a driver's mobile device: receive Wi-Fi data packets from the rider's mobile device at the driver's mobile device, measure and extract channel state information (CSI) from the received Wi-Fi data packets, execute the AoA application to determine the angle of arrival based on the CSI, and display, on the user interface, a coarse-grained location of the rider based on the determined angle of arrival.

According to an embodiment, a method for assisting drivers and riders to find each other includes receiving a location of a rider device at a driver device via GPS, and performing the following steps in response to the location of the rider device being within a threshold distance from the driver device: utilizing a Wi-Fi antenna at the driver device to detect Wi-Fi signals emanating from the rider device, receiving Wi-Fi data packets from the rider device, extracting channel state information (CSI) from the received Wi-Fi data packets, determining an angle of arrival based on the CSI, and displaying on a user interface a location of the rider device based on the determined angle of arrival.

According to an embodiment, a dashcam display for assisting drivers and riders to find each other in a ride-hailing environment includes: one or more Wi-Fi antennas configured to receive Wi-Fi data packets from a rider's mobile device; a wireless transceiver configured to communicate with a driver's mobile device; a storage configured to maintain an angle of arrival (AoA) application that, when executed, determines an angle of arrival of an incoming Wi-Fi signal from the rider's mobile device; and a processor coupled to the storage and the wireless transceiver. The processor is programmed to: receive Wi-Fi data packets from the rider's mobile device, measure and extract channel state information (CSI) from the received Wi-Fi data packets, execute the AoA application to determine the angle of arrival based on the CSI, and cause the wireless transceiver to send a signal to the driver's mobile device to display a location of the rider based on the determined angle of arrival.

### BRIEF DESCRIPTION OF THE DRAWINGS

FIG. 1 illustrates an interior cabin of a vehicle having a mobile device for viewing a rider's location in a ride-hailing application, according to an embodiment.

FIG. 2 is a dashcam display according to an embodiment.

FIG. 3 illustrates an example of a system for assisting drivers and riders to locate each other, according to an embodiment.

FIG. 4 illustrates a signal processing flow chart from a rider's mobile device to a driver's mobile device, according to an embodiment.

FIG. 5 is a flowchart for assisting drivers and riders to locate each other, according to an embodiment.

FIG. 6 is a flowchart for assisting drivers and riders to locate each other, according to an embodiment.

FIG. 7 is a flowchart for assisting drivers and riders to locate each other, according to an embodiment.

FIG. 8 is a flowchart for assisting drivers and riders to locate each other, according to an embodiment.

FIG. 9 illustrates an interior cabin of a vehicle having a mobile device for viewing a rider's location with a fine-grained location in a ride-hailing application, according to an embodiment

FIG. 10 is a flowchart for assisting drivers and riders to locate each other, according to an embodiment in which signal processing of wireless data and image detection is fused or matched for enhanced location determination.

FIG. 11 illustrates an example output of a human-detection application that places bounding boxes around detected humans, according to an embodiment.

FIG. 12 illustrates an example output of a fusion of the human-detection application and signal processing of wireless data to place a bounding box about the identified person, according to an embodiment.

FIG. 13 illustrates an overhead view of a rider hailing a driver with information provided to the rider, such as the angle of arrival and distance to the driver's vehicle, according to an embodiment.

FIG. 14 illustrates an overhead map view of a location of the rider and the driver that can be viewable on the rider device, according to an embodiment.

FIG. 15 is a perspective view of an augmented reality embodiment in which the rider can hold up his/her mobile device to view the environment and the driver's vehicle can be highlighted, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As people are relying on ride-hailing services (e.g., UBER, LYFT), it becomes increasingly important for the drivers and the riders to find each other. Currently, drivers and riders use mobile devices (e.g., smartphones) to find each other through an application provided by the ride-hailing service. The driver and the rider can locate each other based on global positioning system (GPS) signals. However, in urban cities and areas like downtown where large buildings and skyscrapers exist, GPS signals are not always reliable. There are also places such as airports where the drivers may have to come inside to pick up passengers, and GPS may not work inside. Also, in crowded environments like stadiums, airports, theaters, and bars, it may also be difficult to locate the actual rider on the street or sidewalk among many other people that are also standing on the street or sidewalk. This also gets worse in times of reduced visibility, such as at night or during bad weather (e.g., rain, snow, etc.).

Riders have complained about the ability to locate the hailed driver, or the ability for the driver to locate the rider. This can waste the time of the drivers and the riders, forcing them to call each other on the phone to discuss where exactly they are. This wasted time translates into loss of income for the drivers. If drivers can save one minute per trip during a pickup, over the course of a day that could translate into one or more entire trips worked by the driver. This causes frustration and can create a bad user experience. This also creates crowded curbsides in downtown areas.

According to various embodiments described herein, this disclosure proposes novel techniques to enable a ride-hailing service driver to better locate a ride-hailing service rider, and vice versa. In embodiments, the driver has a mobile device in his/her vehicle that is able to communicate with the mobile device of the rider via Wi-Fi when the driver and rider are within a certain distance from one another. This may supplement or replace the GPS-based locational systems currently employed by the ride-hailing service provider. For example, the driver and rider may each locate one another through GPS signals and map-based features until the driver is within Wi-Fi range of the rider. Then, the driver's mobile device may initiate a connection directly with the rider's mobile device via Wi-Fi, and initiate a transfer of data packets from the rider to the driver. In another embodiment, the driver's mobile device listens to all the incoming Wi-Fi packets without establishing a direct connection with the rider's mobile device. The data received via the Wi-Fi connection are then used to estimate the distance and Angle of Arrival (AoA) of the Wi-Fi received packets. In embodiments, a camera provided on the driver's mobile device—or elsewhere in the vehicle—captures images of the surrounding. Object detection is utilized, as well as angle and distance estimation for each person detected. The image-based data is fused with the Wi-Fi-based data, and matching results allow the fine-grained location of the rider to be determined.

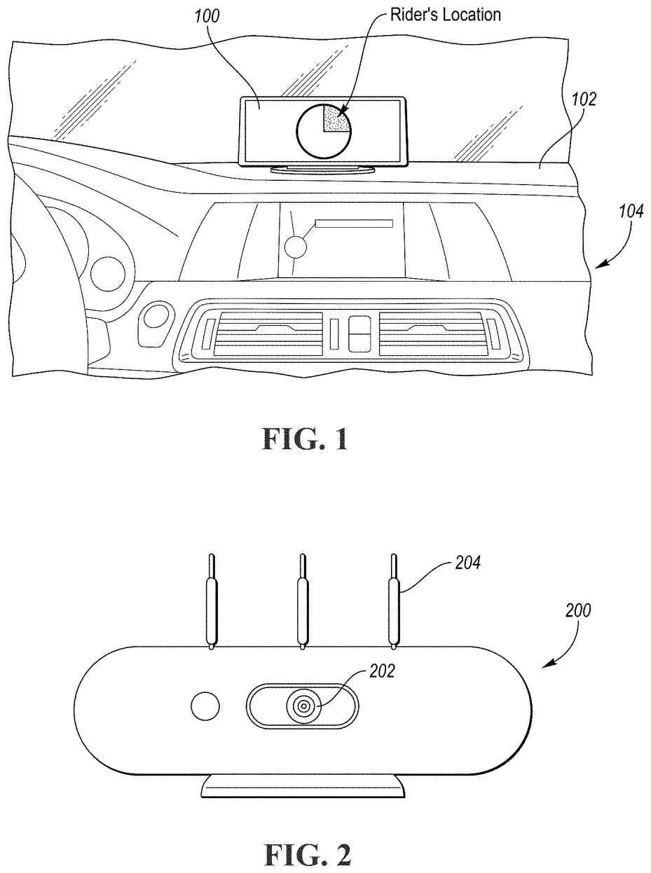

FIG. 1 illustrates an example of a mobile device 100 for informing the driver of the location of the rider that has hailed a ride. The mobile device 100 can be a cell phone, smart phone, tablet, wearable technology (e.g. smart watch), GPS map device, or any other such device that enables a user (e.g., the driver) to view the location of the rider that is hailing the ride. To communicate with the rider that is hailing the ride, the mobile device 100 may be equipped with wireless communication capabilities such as 5G, LTE, Wi-Fi, Bluetooth, GPS/GNSS, and the like. A corresponding receiver or transceiver may be provided in the mobile device 100 for that specific wireless communication protocol. For example, if Wi-Fi is utilized in the system described herein, the mobile device may be provided with an IEEE 802.11 transceiver.

The mobile device 100 is shown mounted to a dashboard 102 of a vehicle 104. This mounting can be via a holder, allowing the mobile device 100 to be removed from the holster that is more securely attached to the dashboard 102.

The mobile device may also be in the form of a dashcam display 200, shown generally in FIG. 2, also referred to as a dashcam. The dashcam display 200 may include all of the communication capabilities of a mobile device such as Wi-Fi, Bluetooth, LTE, cellular, etc. The dashcam display 200 may include a camera 202 that faces toward the windshield of the vehicle to capture images of the environment forward of the vehicle. The dashcam display 200 may also include Wi-Fi antennae 204, or receiver or transceiver. The Wi-Fi antennae may be externally mounted such that they are protuberances from the main housing of the dashcam display 200. On an opposite side of the dashcam display 200 from the camera 202 may be a display that provides the driver with similar information as the mobile device 100, such as the location of the rider for example. The side of the dashcam display 200 with the display may also include a second camera, this time facing the interior of the vehicle to monitor and capture images and/or videos of the driver and passengers within the vehicle. Such information may be helpful for ride-hailing services and their drivers. A microphone may also be provided in the dashcam display 200. In another embodiment, dashcam display 200 may localize the rider and then communicate with a smartphone of the driver using Bluetooth or Wi-Fi to show the location of the rider in the smartphone of the driver as shown in FIG. 1. In such an embodiment, the dashcam display 200 may include a wireless transceiver (e.g., Bluetooth transceiver, Wi-Fi transceiver, etc.) configured to send information wirelessly to the smartphone of the driver, such as the location of the rider after processing such information at the dashcam display 200.

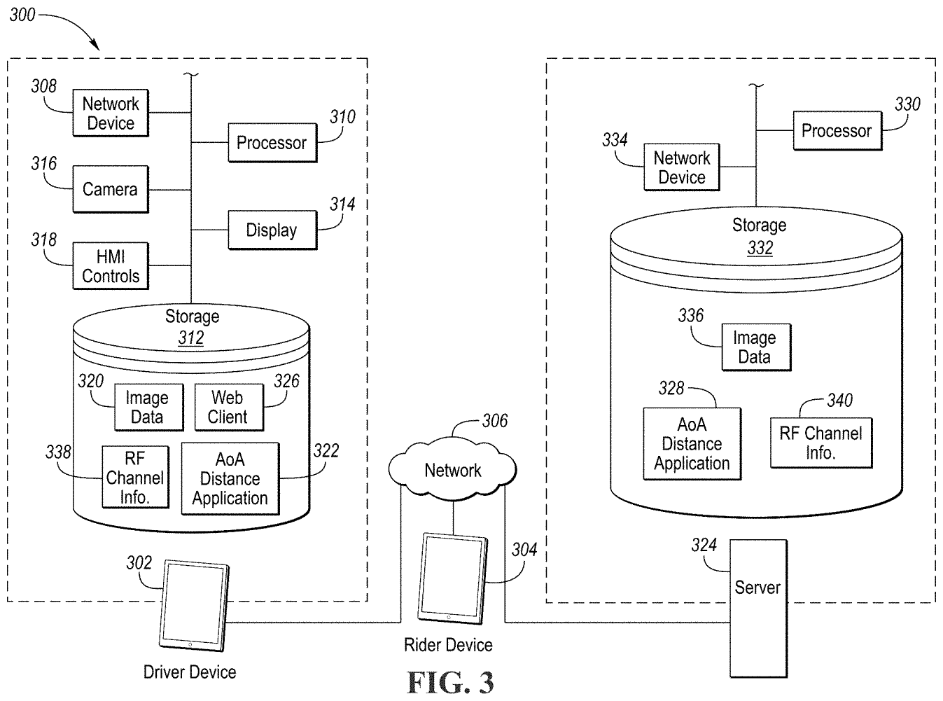

FIG. 3 illustrates an example system 300 for assisting drivers and riders to locate each other. In general, the system 300 enables communication between the driver's mobile device (“driver device”) and the ride-hailing rider's mobile device (“rider device”) through a wireless communication network. As will be explained, the driver device can see the location of the rider device via GPS data, and then once within a certain range, can communicate directly with the rider device via Wi-Fi for a more accurate determination of the location of the rider device. In the illustrated embodiment, the system also enables at least the driver's device to access a server equipped to perform data processing such as machine learning, signal processing, angle of arrival determinations, and distance determinations, based on the data communicated between the driver device and rider device via Wi-Fi.

In one or more embodiments, the system 300 includes a driver device 302 and a rider device 304 that are able to communicate data back and forth over a network 306. The driver device 302 and rider device 304 may each include a network interface card 308 that enable the respective devices 302, 304 to connect to send and/or receive data to and from each other, and to other external devices (such as the server 324 explained below) over the network 306. The driver device 302 and rider device 304 may each be a mobile device (e.g., mobile device 100) having wireless communication technology described herein, such as a Wi-Fi transceiver configured to communicate Wi-Fi packets. Also, the driver device 302 can be a dashcam with the aforementioned wireless communication technologies.

The driver device 302 also includes a processor 310 that is operatively connected to a storage 312, a display device 314, a camera 316, human-machine interface (HMI) controls 318, and the network device 308. Images or videos taken by the camera 316 can be stored as image data 320 in the storage 312. The storage 312, when accessed by the processor 310, may be configured to enable execution of various applications and signal processing, such as processing of image data 320 or executing an AoA and/or distance application 322. All disclosed functions for determining the location of the rider device 304 may be performed locally at the driver device. Alternatively, as illustrated in FIG. 3, the driver device 302 may be configured to connect to a server 324, which performs such signal processing and provides the output of said processing to the driver device 302 via the network 306. The driver device 302 may be provided with this data through a web client 326, which may be a web browser or application executed by the driver device 302. The server 324 may host its own AoA and/or distance application 328 that is accessible by the driver device 302 via the network 306. The server 324 also includes a processor 330 that is operatively connected to a storage 332 and to a network device 334. The server 324 may also include image data 336 that is sent there via the network 306 from the camera 316 of the driver device 302. The server 324 may also host instructions that enable a machine learning model to be utilized by the processor 330. This machine learning model can be accessible by the processor 330 and/or the processor 310 of the driver device 302.

It should be noted that the example system 300 is one example, and other systems consisting of multiple units of 100 may be used. For instance, while only one driver device 302 is shown, systems disclosed herein including multiple driver devices 302 are contemplated. As another possibility, while the example implementation is shown as a web-based application, alternate systems may be implemented as standalone systems, local systems, or as client-server systems with thick client software. Various components such as the camera 316 and associated image data 320 may be received and processed locally at the driver device 302 by the processor 310, or may be sent to the server 324 via the network for processing by the processor 330, the results of which can be sent back to the driver device 302.

Each of the processor 310 of the driver device 302 and the processor 330 of the server 324 may include one or more integrated circuits that implement the functionality of a central processing unit (CPU) and/or graphics processing unit (GPU). In some examples, the processors 310, 330 are a system on a chip (SoC) that integrates the functionality of the CPU and GPU. The SoC may optionally include other components such as, for example, the storage 312 or 332 and the network devices 308 or 334 into a single integrated device. In other examples, the CPU and GPU are connected to each other via a peripheral connection device such as PCI express or another suitable peripheral data connection. In one example, the CPU is a commercially available central processing device that implements an instruction set such as one of the x86, ARM, Power, or MIPS instruction set families.

Regardless of the specifics, during operation, the processors 310, 330 execute stored program instructions that are retrieved from the storages 312, 332, respectively. The stored program instructions accordingly include software that controls the operation of the processors 310, 330 to perform the operations described herein. The storages 312, 332 may include both non-volatile memory and volatile memory devices. The non-volatile memory includes solid-state memories, such as NAND flash memory, magnetic and optical storage media, or any other suitable data storage device that retains data when the system 300 is deactivated or loses electrical power. The volatile memory includes static and dynamic random-access memory (RAM) that stores program instructions and data during operation of the system 100.

The GPU of the driver device 302 may include hardware and software for display of at least two-dimensional (2D) and optionally three-dimensional (3D) graphics to a display device 314 of the driver device 302. The display device 314 may include an electronic display screen, such as LED, LCD, OLED, or the like. In some examples, the processor 310 of the driver device 302 executes software programs using the hardware functionality in the GPU to accelerate the performance of machine learning or other computing operations described herein.

In other embodiments, the display device 314 includes a heads-up display (HUD) configured to display information onto the windshield of the vehicle. The HUD may be part of the vehicle's system rather than the driver device 302, but may nonetheless be in communication with the driver device 302 for display of such information. For example, the driver device 302 may execute the AoA and/or distance application 322 for course-grained or fine-grained location determination of the rider device 304 as explained herein, and can send the locational information to the HUD of the vehicle such that the location of the rider can be displayed on the windshield of the vehicle for ease of view by the driver. The vehicle may include its own object-detecting sensors (e.g., LIDAR, RADAR, etc.) and associated software executable by a vehicle processor for determining the presence of a human; this information can be fused with the image data 320 and/or the results of the AoA and/or distance application 322 such that the HUD system can determine or verify the location of the rider hailing the driver for a ride, and highlight or otherwise indicate the location of that rider on the windshield.

The HMI controls 318 of the driver device 302 may include any of various devices that enable the driver device 302 of the system 300 to receive control input from a driver. Examples of suitable input devices that receive human interface inputs may include a touch screen on the driver device 302, but can also include keyboards, mice, trackballs, voice input devices, graphics tablets, and the like. As described herein, a user interface may include either or both of the display device 314 and HMI controls 318.

The network devices 308, 334 may each include any of various devices that enable the driver device 302 and server 324, respectively, to send and/or receive data from external devices over the network 306. Examples of suitable network devices 308, 334 include a network adapter or peripheral interconnection device that receives data from another computer or mobile device, or external data storage device, which can be useful for receiving large sets of data in an efficient manner.

The AoA and/or distance application 322 is present on the driver device 302 and executable by the processor 310. Alternatively, or in combination, the AoA and/or distance application 328 is present on the server 324 such that off-site processing (e.g., remote from the driver device 302) can be performed by the processor 330 accessing the application 328. In either embodiment, the AoA and/or distance application 322, 328 may use various algorithms to perform aspects of the operations described herein. In an example, the AoA and/or distance application 322, 328 may include instructions executable by the respective processor 310, 330. The AoA and/or distance application 322, 328 may include instructions stored to the respective memory 312, 332 executable by the respective processor 310, 330. Computer-executable instructions may be compiled or interpreted from computer programs created using a variety of programming languages and/or technologies, including, without limitation, and either alone or in combination, JAVA, C, C++, C#, VISUAL BASIC, JAVASCRIPT, PYTHON, PERL, PL/SQL, etc. In general, the processor 310, 330 receives the instructions, e.g., from the respective storage or memory 312, 332, a computer-readable medium, etc., and executes these instructions, thereby performing one or more processes, including one or more of the processes described herein. Such instructions and other data may be stored and transmitted using a variety of computer-readable media.

The AoA and/or distance application 322, 328, when executed by the respective processor 310, 330, can use channel state information (CSI) extracted from Wi-Fi packets transmitted from the rider device 304 to the driver device 302 to determine an angle of arrival, and/or a distance between the driver device 302 and rider device 304. In short, several methods can be used to estimate distance and/or angle of arrival, such as signal processing (e.g., MUSIC algorithm, SpotFi algorithm, Synthetic Aperture method, Doppler shift estimation, etc.) or machine learning (e.g., Long Short-Term Memory (LSTM), or neural network-based approach based on training of the neural network to estimate the AoA and distance by collecting additional data in prior steps, and comparing the current data to the previously-collected data). Further explanation of the AoA and/or distance application 322, 328 is provided herein.

In artificial intelligence (AI) or machine learning systems, model-based reasoning refers to an inference method that operates based on a machine learning model of a worldview to be analyzed. As described herein, the machine learning model may be accessed and executed directly at the driver device 302 using the AoA and/or distance application 322, or may be executed at the server 324 using the AoA and/or distance application 328 and accessed via the network 306. Both embodiments are shown in FIG. 3. Generally, the machine learning as utilized by the AoA and/or distance application 322, 328 is trained to learn a function that provides a precise correlation between input values and output values. At runtime, a machine learning engine uses the knowledge encoded in the machine learning model against observed data to derive conclusions such as a diagnosis or a prediction. One example machine learning system may include the TensorFlow AI engine made available by Alphabet Inc. of Mountain View, Calif., although other machine learning systems may additionally or alternately be used. As discussed in detail herein, the AoA and/or distance application 322, 328 may utilize the machine learning models described herein and configured to recognize features and information contained within transmitted Wi-Fi packets (e.g., RF channel information) for use in determining fine-grained location of the rider device 304. In short, the machine learning model may obtain RF channel information from Wi-Fi packets (including channel estimation parameters such as received signal strength, peak power or average power, phase etc. for whole channel or individual sub-channels, impulse response for wide-band channels, etc.), and utilize a neural network-based approach to estimate the AoA and/or direction of the Wi-Fi received packet.

The storage 312 may also include radio frequency (RF) channel information 338. Likewise, if processing such as the AoA and/or distance application is performed by the server 324, the storage 332 can include RF channel information 340. As explained herein, once the driver device 302 and rider device 304 are able to communicate via Wi-Fi, Wi-Fi packets are transmitted from the rider device 304 to the driver device 302. When a Wi-Fi packet is received at the driver device 302, the associated channel state information (CSI) is extracted from the physical layer. The CSI provides rich information about how a wireless signal propagates from the Wi-Fi transmitter (e.g., the rider device) to a receiver (e.g., the driver device), and captures the combined effect of signal scattering, fading, and power decay with distance. RF channel information 338 is also determinable from the packets received by the driver device. The RF channel information can include channel estimation parameters such as received signal strength, peak power or average power, phase, etc. for the whole channel or individual sub-channels, impulse response for wide-band channels, etc. The AoA and/or distance application 322, 328 can utilize the CSI to estimate the distance and/or angle of arrival using signal processing or machine learning as described herein. After the AoA and/or distance estimation, a classifier is used to estimate a coarse-grained location of the rider based on the RF channel information 338, 340. The coarse-grained location can be whether the rider is in front or back of the vehicle, and whether the rider is at the left side or right side of the vehicle. As a classifier, a neural network may be used or other classifiers can be used, such as support-vector machines (SVM).

The web client 326 may be an application or “app” on the driver device 302, or a web browser, or other web-based client, executed by the driver device 302. When executed, the web client 326 may provide an interface to allow the driver to view the location of the rider, communicate directly with the rider, access GPS direction information for driving the vehicle, and the like. In the case where the machine learning, signal processing, and/or AoA and/or distance application is performed at the server 324 or by the processor 330, the web client 326 can access the AoA and/or distance application 328 to receive results of such processing or machine learning models. In a practical example, the web client 326 may be an app on the driver device 302 controlled by the ride-hailing service provider (e.g., an UBER app or a LYFT app) that accesses processed information and displays such information on the driver device 302, such as the location of the rider device 304. The web client 326 may further provide input received via the HMI controls 318 to the AoA and/or distance application 328 and/or machine learning model of the server 324 over the network 306.

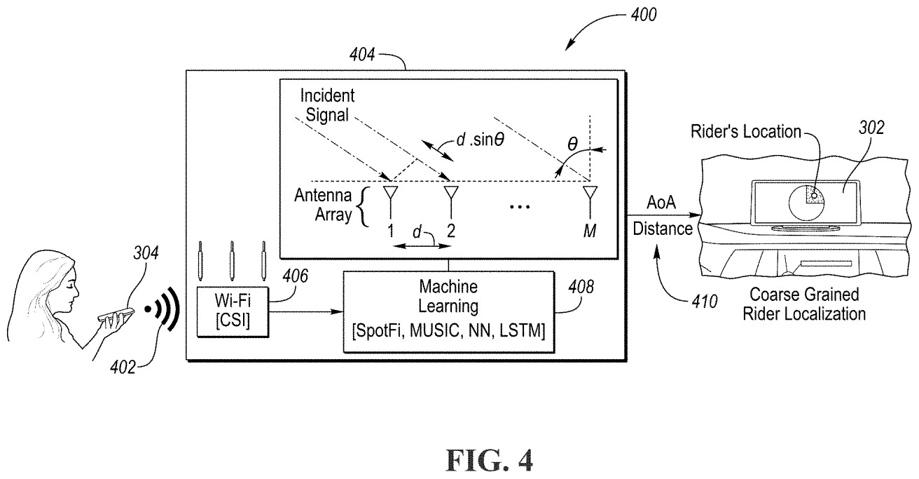

FIG. 4 is an example system 400 for transmitting Wi-Fi packets from the rider to the driver to assist the driver to better locate the rider. Box 404 can be a dashcam (such as dashcam 200) or mobile smartphone that receives WiFi packets from the rider. While this description and Figure illustrates data transmission from the rider device 304 to the driver device 302, it should be understood that the same system can be used to transfer data from the driver device 302 to the rider device 304 to assist the rider to better located the driver.

In standard ride-hailing services, a rider desires a ride from a driver, and hails a ride by accessing the ride-hailing service provider's app or website. A connection between the driver and the rider is made, and both rider and driver can view each other's location via GPS. However, as described herein, GPS has its limitations and faults, particularly in urban areas with tall buildings or large crowds that can interfere with GPS signal strength. The system described herein describes establishing a Wi-Fi connection between the driver and the rider once within a threshold distance. The system described herein and illustrated in a simplistic form in FIG. 4 can take place once such a connection is made.

When the GPS indicates that the driver is reaching close to the rider and comes within a threshold distance (e.g., 0.5 mile radius), the rider device 304 begins to transmit Wi-Fi packets. Simultaneously, the driver device 302 begins to listen to incoming Wi-Fi signals via its Wi-Fi transceiver or receiver. This threshold distance can be set by the service provider, and can vary based on circumstances. For example, at times or locations in which GPS signal quality may be low, the threshold distance may increase, so that even weak Wi-Fi signal transmissions can be listened to and established. Likewise, at times or locations in which GPS signal quality is strong, the threshold distance may be lowered such that the GPS signal can be relied upon until the driver and rider are very close together, due to the good GPS signal.

It should be understood that the driver device 302 can include two devices, such as a dashcam device 200 and a smartphone of the driver. In that embodiment, the dashcam 200 can listen to the incoming Wi-Fi packets, perform the extraction and signal processing and/or models described herein, and transfer a coarse- or fine-grained location to the smartphone for display on the driver's smartphone. In other embodiments, these functions are all performed by a single device, such as a dashcam device 200 or smartphone.

Once the driver device 302 detects a Wi-Fi signal emanating from the rider device 304, a Wi-Fi transmission can occur, shown generally at 402. One or more Wi-Fi packets generated by the rider device 304 are received by the transceiver or antennae of the driver device 302. At box 404, the driver device 302 performs various actions, such as extracting CSI, and determining the AoA and/or distance to the rider device 304. First, in an embodiment, the MAC address of the rider device 304 is shared with the driver device 302 so that the driver device 302 knows which messages to listen to, or which messages are coming from the rider device 304. To ensure regulatory compliance, the rider's approval may be obtained before sharing the MAC address. Further, to protect security and privacy, a temporary MAC address can also be assigned to the rider which is used for creating these messages. The temporary MAC address can be generated in at least two ways. In one way, the ride-hailing service provider's app creates a temporary MAC address which it shares with both the rider device and the driver device. And in another way, the rider device 304 may create a temporary MAC address and inform the app, which in turn informs the driver device 302.

When a Wi-Fi packet is received at the driver device 302, associated Channel State Information (CSI) is measured and extracted from the physical layer, as shown generally at 406. Channel State Information represents channel properties of the wireless link. It provides rich information about how a wireless signal propagates from the transmitter to a receiver and captures the combined effect of signal scattering, fading, and power decay with distance.

The CSI values are then used to estimate the distance to the rider device 304 and/or the angle of arrival (AoA) of the packet received from the rider device 304 via the Wi-Fi transmission 402. This is shown generally at 408. This can be done using either a signal processing approach or a machine learning approach, as will be described further below. The output of this step is a determination of the AoA and/or distance to the rider device 304, which is shown generally at 410. At 408, the CSI values are analyzed using signal processing algorithms, e.g., SpotFi, MUSIC, Synthetic Aperture method, Doppler shift estimation, or by using AI-based techniques, e.g., LSTM, Neural Network to determine Angle of Arrival (AoA) and estimate range of the rider. It can use a combination of signal processing and AI-based approach. For example, the multipaths output of SpotFi may be used as an input for an AI-based approach that eventually determines the AoA or coarse-grained localization of the rider. The results of the AoA and/or distance determination is shown at 410, which is the output of the AoA and/or distance application 322, 328.

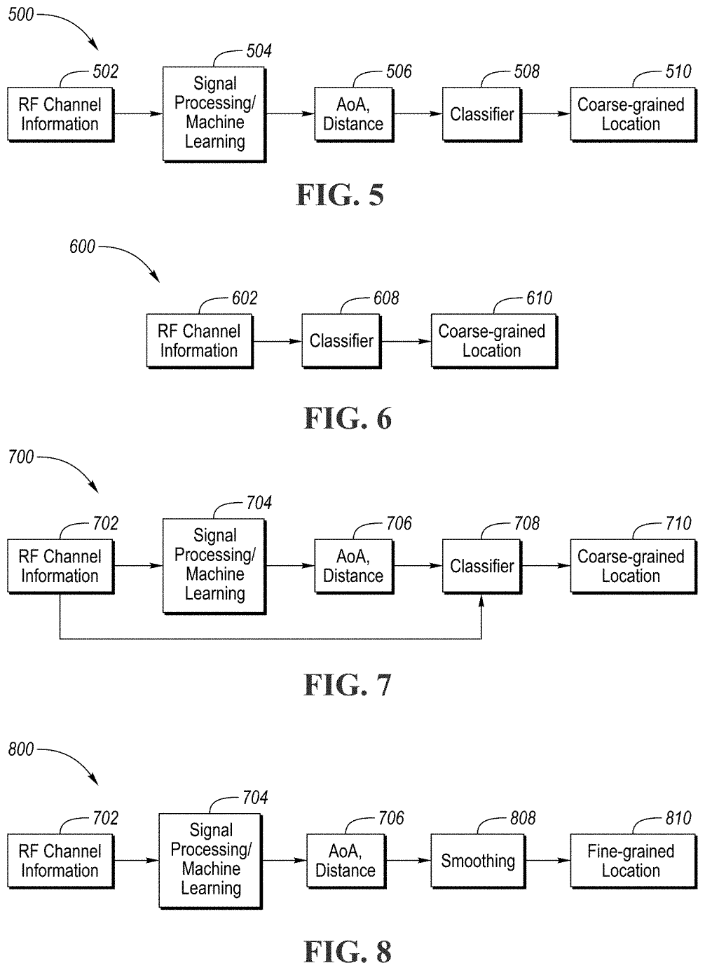

Referring to FIG. 5, a flow chart 500 for determining coarse-grained location of a rider device is illustrated. The flow chart illustrates RF channel information at 502, signal processing and/or machine learning at 504, AoA and/or distance at 506, classifier at 508, and a coarse-grained location at 510. These steps incorporate the description made above, and will be further described below.

At 502, RF channel information (e.g., CSI data) is obtained from the Wi-Fi packets from the rider device 304 once driver device 302 receives Wi-Fi packets from rider device 304. This may be stored in storage at 312, 332 to be accessed by the associated processor. When a Wi-Fi packet is received at the driver device 302, the associated CSI is extracted from the physical layer and provides rich information about how a wireless signal propagates from the transmitter to a receiver and captures the combined effect of signal scattering, fading, and power decay with distance. The RF channel information may include channel estimation parameters such as received signal strength, peak power or average power, phase etc. for whole channel or individual sub-channels, impulse response for wide-band channels, and the like. CSI can describe how a signal propagates from the rider device 304 to the driver device 302 and represents the combined effect of, for example, scattering, fading, and power decay with distance. Two levels of CSI can be extracted from the Wi-Fi packets: instantaneous CSI (also referred to as short-term CSI), or statistical CSI (also referred to as long-term CSI). The description in a statistical CSI can include, for example, the type of fading distribution, the average channel gain, the line-of-sight component, and the spatial correlation. Either or both types of CSI can be determined from the Wi-Fi packets.

At 504, the CSI values are used to estimate the AoA and/or distance between the driver device 302 and rider device. This can be performed utilizing the AoA and/or distance application 322, 328, and is also shown at 408. The output of such determination is shown at 506. At 504, several methods can be used to estimate the distance and AoA. Once such method is a signal processing approach. One example of a signal processing method includes utilizing a multiple signal classification (MUSIC) algorithm for radio direction finding. MUSIC estimates the frequency content of the signal or autocorrelation matrix using an eigenspace method. The image at 408 represents an example of estimating AoA with MUSIC. Since different propagation paths have different AoAs, and when the signal from a propagation path is received across an array of antennas, then the AoA will introduce a corresponding phase shift across the antennas in the array. The introduced phase shift is a function of both the distance between the antennas and the AoA. At 408, a uniform linear array comprising M antennas is shown. For AoA of 0, the target's signal travels an additional distance of d× sin(θ) to the second antenna in the array compared to the first antenna. This results in an additional phase of −2π×d× sin(θ)×ƒ/c at the second antenna, where c is the speed of light and ƒ is the frequency of the transmitted signal.

A SpotFi algorithm can also be utilized for estimation of AoA and/or distance. The distance between the driver device 302 and the rider device 304 can be estimated using the received signal strength. Complex algorithms such as SpotFi can give both angular information and distance between the two devices. SpotFi can incorporate super-resolution algorithms that can accurately compute the AoA of multipath components even when the access point has multiple antennas (at least two). SpotFi can also incorporate novel filtering and estimation techniques to identify AoA of direct path between the rider device 304 and the driver device 302 by assigning values for each path depending on how likely the particular path is the direct path. The distance can also be estimated using RSSI of the received packet and using a log-distance path loss model.

Another such method to estimate the distance and AoA is utilizing machine learning. A neural network-based approach can be used to estimate the AoA of the Wi-Fi packet received by the rider device 304. This approach may require training of the neural network to estimate AoA and distance by collecting additional data as a prior step. The machine learning algorithms can take raw CSI values as inputs in order to estimate AoA and perform coarse-grained localization as shown in FIG. 6. Alternately, the machine learning algorithms can take outputs of signal processing algorithms, e.g., the multipath AoAs of SpotFi as inputs and perform coarse-grained localization without seeing the raw CSI values as shown in FIG. 5. In another embodiment, the machine learning algorithm can take input of the combination of raw CSI values and output of signal processing algorithms in order to perform coarse-grained localization as shown in FIG. 7.

After the AoA and distance estimation using Wi-Fi produces results at 506, then a classifier is used at 508 to estimate a coarse-grained location of the rider. The coarse-grained location can be whether the rider is in front or back of the driver's vehicle, and whether the rider is at the left side or right side of the vehicle. As a classifier, a neural network may be used or other classifiers can be used, e.g., Support Vector Machine (SVM). Of course, the coarse-grained location can be estimated at the driver device 302 by AoA and/or distance application 322, or at the server 324 by AoA and/or distance application 328. The classifier captures a model of how the CSI values or AoAs would change for different locations of the wireless transmitter of the rider's device, i.e., the location of the rider based on the previously observed samples and use that model to determine the location of the rider based on future Wi-Fi received packets. The output is the coarse-grained location at 510. In another embodiment, when performing coarse-grained localization classification, instead of doing a 4-way quadrant-based classification, the classifier employs a hierarchical classification. First, it classifies whether the rider is in front or back of the car. Then, it determines whether the rider is in the left or right side of the car.

The location information can be updated continuously in real-time as the driver's vehicle (and thus the driver device 302) moves and newer Wi-Fi packets are received from the rider device 304.

FIG. 6 illustrates another embodiment of a flow chart 600 for determining coarse-grained location of a rider device. In this embodiment, the coarse-grained location 610 is estimated directly from the CSI values 602 using a classifier 608 (neural network based, SVM based, or other techniques) without estimating Angle of Arrival (AoA).

FIG. 7 illustrates another embodiment of a flow chart 600 for determining coarse-grained location of a rider device. In this embodiment, the RF channel information of CSI values 702 feed directly into the classifier at 708, as well as the signal processing or machine learning at 704. The coarse-grained location 710 is estimated using a classifier 708 (neural network based, SVM based, or other techniques) that uses both AoA estimation 706 (estimated as mentioned above) and raw CSI values 702.

In another embodiment, the classifier can also obtain AoA & distance estimates from GPS and decide location based on combination or fusion of estimates from GPS and Wi-Fi data.

A fine-grained location of the rider device 304 can also be estimated. An example of fine-grained estimation is shown in the flowchart 800 of FIG. 8. In this embodiment, once again the CSI data or RF channel information 702 is obtained, signal processing or machine learning 704 is performed by the processor, resulting in AoA and/or distance at 706 based on the received Wi-Fi packets. After the AoA is estimated, the sequence of multiple AoAs captured from multiple Wi-Fi packets are smoothed at 808 by the processor. The smoothing 808 can be performed using moving average, LOESS (Locally Estimated Scatterplot smoothing), LOWESS (Locally Weighted Scatterplot Smoothing), another neural network, or other smoothing techniques. Smoothing results in the fine-grained location 810.

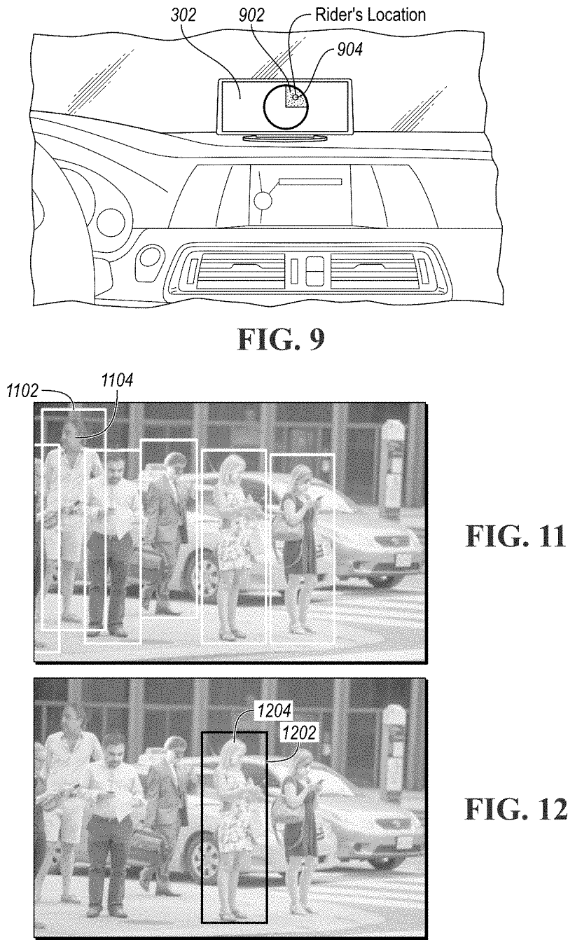

An example of coarse-grained location of the rider is shown in FIG. 9. The driver device 302 (e.g., dashcam unit 200) is once again shown mounted within the vehicle. The driver device 302 can display both the coarse-grained and fine-grained location, overlapped on the same display 314. Here, the coarse-grained location is illustrated by the wedge 902 of the overall circle. This wedge shows a general direction of where the rider device is. In other embodiments, the wedge 902 is an arrow, line, or other type of indicator to show general direction. Also, the arrow or wedge can alter in size or intensity that corresponds to the distance from the rider device 304. The coarse-grained location is shown in isolation in FIG. 1, without the fine-grained location provided. The coarse-grained location is illustrated by a dot 904. In this embodiment, the location of the rider is approximately 45 degrees to the side and forward relative to the Wi-Fi antenna of the rider device 304.

The fine-grained location can also be fused with GPS data that is used to produce a map on the driver device 302. For example, the service provider's app that is displayed on the display of the driver device 302 may include a map for navigation purposes. The fine-grained location as determined from the Wi-Fi packets can be overlaid onto the GPS-based map to give the driver an accurate view of the location of the rider.

In some embodiments, the driver may be using two mobile devices, such as dashcam 200 and a smartphone. In such embodiments, the smartphone may be more suitable for displaying information to the driver, such as the GPS map and the like, whereas the dashcam 200 may be executing the AoA and/or distance application and other processing described herein. Additionally, the dashcam 200 may perform the communication via Wi-Fi with the rider device, perform the locational processing, and send a signal to the driver's smartphone regarding the determined location of the rider. The signal sent from the dashcam to the smartphone can be made via Bluetooth or Wi-Fi, (e.g., via a wireless transceiver) or wired connection. After the coarse-grained or fine-grained location of the rider is estimated at the driver side by the dashcam 200, this information may be shared with the smartphone of the driver and/or the rider using a direct connection, or a wireless connection (Bluetooth, Wi-Fi, cellular, etc.). This information can then be visualized at the driver's smartphone in a way that shows the relative location of the vehicle with respect to the rider device.

After the coarse-grained or fine-grained location of the rider device 304 is estimated by the driver device 302, this information may be shared with the rider device 304. Such information transfer may be via the established Wi-Fi connection, or other wireless connection (e.g., LTE, cellular, 4G, 5G, etc.). This information can be visualized at the rider device 304 in a way that shows the relative location of the driver's vehicle with respect to the rider device 304.

As explained above, the driver device 302 may be equipped to capture images via a camera 316 to produce image data 320 accessible by the processor 310. This camera 316 may be the camera of a smartphone, or the camera 202 of the dashcam 200. The camera 316 may also be one or more cameras mounted about a vehicle to capture images of the environment about the vehicle. In an embodiment, the system disclosed herein can fuse the image data with the data extracted from the Wi-Fi packets to further help drivers and riders locate each other.

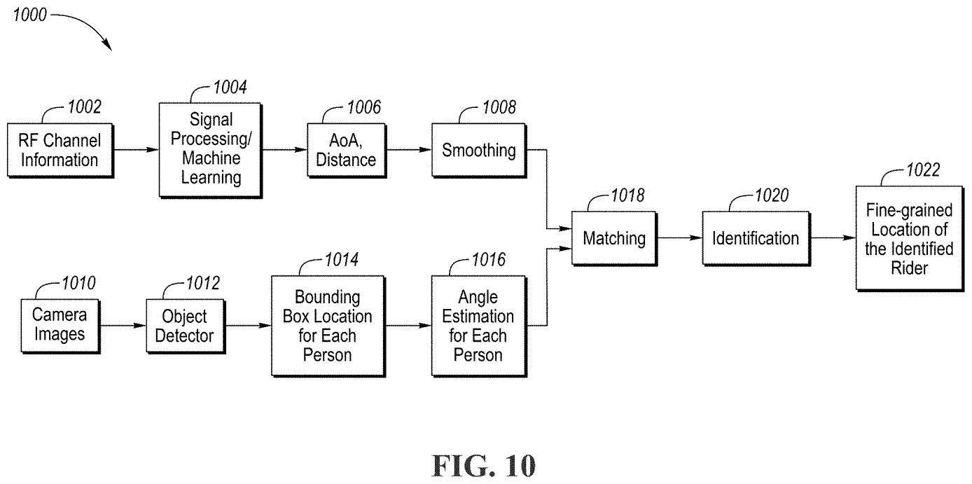

FIG. 10 illustrates an embodiment of a flow chart 1000 of a system for determining fine-grained location of a rider device based on wireless packet information fused with image data. The system obtains CSI data or RF channel information at 1002, performs signal processing and/or machine learning 1004 to estimate AoA and/or distance to the rider device at 1006, as explained in previous embodiments described herein. The system may also perform smoothing 1008 as explained with reference to FIG. 8. This produces a Wi-Fi-based data set, or wireless data set that is ready for matching with image-based data.

To obtain the image-based data, the camera 316 obtains images 1010 of a field of view. If the camera 316 is facing out of the windshield, the obtained images would be that of the driver's view through the windshield. In other embodiments, one or more other cameras are placed in other locations, such as facing sideways or rearwardly from the vehicle. The vehicle itself may be equipped with cameras as part of its active safety systems or autonomous driving systems. The images obtained from those system can be shared with the system 100 via wireless or direct transmission.

From the image data 320 that includes the camera images 1010, one or more processors can implement an object-detecting technique 1012 to detect humans in the images. Various object- and human-detecting techniques and models are known, such as You Only Look Once (YOLO), Single Shot Multibox Detector (SSD), Faster R-CNN for example. With YOLO, a single neural network predicts bounding boxes and class probabilities directly from full images in one evaluation. Since the whole detection pipeline is a single network, it can be optimized end-to-end directly on detection performance. With SSD, a single deep neural network is used, which discretizes the output space of bounding boxes into a set of default boxes over different aspect ratios and scales per feature map location. The neural network generates scores for the presence of each object category in each default box and produces adjustments to the box to better match the object shape. Additionally, the network combines predictions from multiple feature maps with different resolutions to naturally handle objects of various sizes. With Faster R-CNN, first in convolution layers filters are trained to extract appropriate features of the image (e.g., a human) and filter those feature; next a small neural network slides on a feature map of the convolution layers and predicts whether there is an object or not and also predict the bounding box of those objects; and finally fully connected neural networks predict object class (classification) and bounding boxes (regression) based on the regions proposed by the RPN. These human-detecting techniques are merely exemplary, and of course others may be used, especially as technology in this area continues to improve.

The output of the human-detection techniques provides bounding boxes around each detected human at 1014. An example of this is shown in FIG. 11, with bounding boxes 1102 placed about each detected human 1104.

At 1016, the processor finds the relative angle of each bounding box. Said another way, the corresponding angle relative to the camera 316 is estimated for each bounding box 1102. As a result, each person seen in the camera images is associated with an angle. In an embodiment, the system can assume A is a set of angles {A1°, A2°, A3°, . . . AN°} for N people detected by the camera. This can be stored as image data 320 or 336.

Since the camera 316 and the Wi-Fi transceiver are both on the same driver device 302, they both share the same coordinate system and can thus the angles computed at 1006 and 1016 can be compared. Amongst a group of people, the rider can be identified by finding the closest match between the AoA determined at 1006 and the angles A determined at 1016 at step 1018. To find the closest match between AoAs, Euclidean distance can be used. This results in an identification of the rider at 1020. Thus, a fine-grained location of the identified rider is presented at 1022.

Once the data rider is identified, the rider can be highlighted, marked, or otherwise identified on the driver device 302. This is shown in FIG. 12, in which a single bounding box 1202 is overlaid or placed over the identified rider 1204. The image shown in FIG. 12 can be displayed on the screen of the driver device 302 so that the driver can visually identify the rider on-screen.

The system of fusing Wi-Fi-based data with image-based data in FIG. 10 can also result in a visualized identification shown in the heads-up display (HUD) of the vehicle. As described above, the vehicle may be equipped with a HUD system. The identification of the rider 1204 may be made via the system described herein, using images from cameras mounted to the vehicle that continuously monitor the surroundings. Once the rider 1204 is in view through the windshield of the vehicle, the HUD system can communicate with the system described herein, and placed a box or other type of indication on the identified rider 1204.

While references to Wi-Fi are described herein, it should be understood that the present disclosure is not limited to Wi-Fi. Other wireless communication technologies can be used, such as Bluetooth, Ultra-wideband, dedicated short-range communication (DSRC), and others, or a combination thereof. For Ultra-wideband, Channel Impulse Response (CIR) can be used instead of CSI. For other technologies, the proposed system may need to capture amplitude and phase of the wireless channels using multiple antennas.

In another embodiment, instead of placing the antennas in a linear array as shown in FIG. 2, they can be placed in a triangular or a rectangular array. In another embodiment, instead of using a single wireless chipset, multiple wireless chipsets can be used.

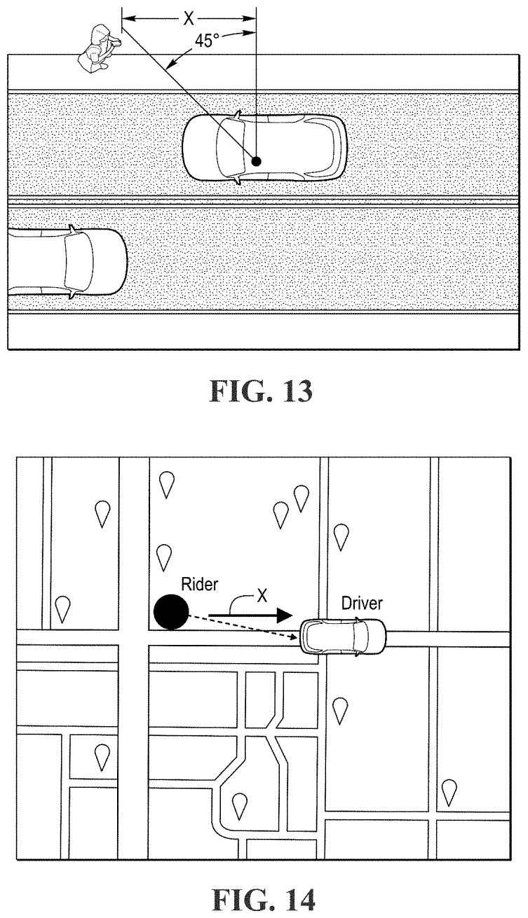

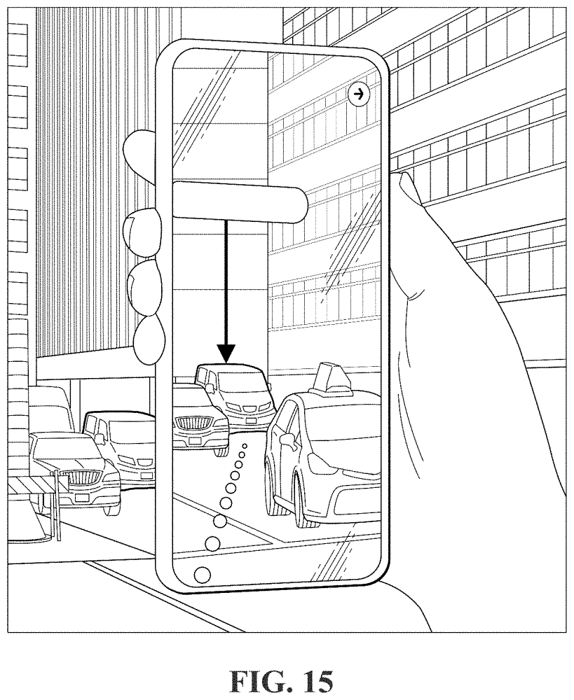

It should also be understood that such localization information can be sent to the rider device to enable the rider to more accurately locate the driver. Such a situation can be helpful if the streets are crowded with many different vehicles and it is hard to tell which vehicle is the actual driver that was hailed for the ride. In one embodiment, after the driver device 302 estimates the location of the rider (either by coarse-grained or fine-grained) as disclosed herein, this localization information can be transmitted through cellular connection or by using Wi-Fi or Bluetooth to the rider device 304. As an example, FIG. 13 shows a case where a car is approaching to the rider, where the driver device 302 estimates that the rider device is in front and right quadrant of the vehicle. It also estimates the AoA of the incoming Wi-Fi signal from the rider device is 45 degrees from the driver device. It can also estimate that distance “X” from the rider device to the driver device. Then, this information can be shown in an app in the rider device as shown in FIGS. 14 and 15. FIG. 14 provides the rider with an overhead view of the location of the car upon a static map. FIG. 15 provides the location of the vehicle using an augmented reality to the rider device. In both FIGS. 14 and 15, the app can show the rider that the driver's car is approaching from the left of the rider at a range of X meters, and at an angle along the dashed line. As the car advances, the angle and distance are updated and shown in the app of the rider device 304. If augmented reality is used, the rider can hold up his/her device as shown in FIG. 15 so that the camera is capturing images of the environment, and then highlight the location of the driver in the environment similar to the embodiments described above, e.g., fusing image data from the rider device's camera with the data transmitted to the rider device.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for assisting drivers and riders to find each other, the system comprising:
a user interface;
a storage configured to maintain an angle of arrival (AoA) application that, when executed, determines an angle of arrival of an incoming Wi-Fi signal; and
at least one processor in communication with the user interface and the storage, the at least one processor being programmed to:
receive a location of a rider's mobile device via GPS,
in response to the location of the rider's mobile device being within a threshold distance from a driver's mobile device:
receive Wi-Fi data packets from the rider's mobile device at the driver's mobile device,
measure and extract channel state information (CSI) from the received Wi-Fi data packets,
execute the AoA application to determine the angle of arrival based on the CSI, and
display, on the user interface, a coarse-grained location of the rider based on the determined angle of arrival.

2. The system of claim 1, wherein the user interface is part of the driver device.

3. The system of claim 1, further comprising a smartphone communicatively connected to the driver's mobile device, wherein the at least one processor is further programmed to, in response to the location of the rider's mobile device being within a threshold distance from the driver's mobile device, transmit the coarse-grained location of the rider from the driver's mobile device to the smartphone such that the coarse-grained location of the rider is displayed on the smartphone.

4. The system of claim 1, wherein the at least one processor is further programmed to, in response to the location of the rider's mobile device being within a threshold distance from the driver's mobile device, obtain radio frequency (RF) channel information from the Wi-Fi packets including at least signal strength information.

5. The system of claim 1, wherein the at least one processor is further programmed to transmit a signal to the rider's mobile device that includes the determined angle of arrival such that the rider's device can display a location of the driver's mobile device.

6. The system of claim 1, wherein the at least one processor is further programmed to, in response to the location of the rider's mobile device being within a threshold distance from the driver's mobile device, determine the course-grained location based on a pre-trained neural network-based classifier that operates on models that compare how the CSI or angle of arrival differs for various locations of rider devices.

7. The system of claim 1, wherein the at least one processor is further configured to, in response to the location of the rider's mobile device being within a threshold distance from the driver's mobile device, determine a fine-grained location of the rider based on the determined angle of arrival.

8. The system of claim 7, further comprising a camera configured to capture images of an environment, wherein the storage is configured to maintain image data relating to the captured images, and the at least one processor is further programmed to, in response to the location of the rider's mobile device being within a threshold distance from the driver's mobile device:
execute an object-detection model based on the image data to detect one or more humans in the environment,
match a detecting human with the determined angle of arrival, and
display, on the user interface, an image of the environment as captured from the camera with an indication overlaid onto the environment that identifies the rider based on the match.

9. A method for assisting drivers and riders to find each other, the method comprising:
receiving a location of a rider device at a driver device via GPS;
in response to the location of the rider device being within a threshold distance from the driver device:
utilizing a Wi-Fi antenna at the driver device to detect Wi-Fi signals emanating from the rider device,
receiving Wi-Fi data packets from the rider device,
extracting channel state information (CSI) from the received Wi-Fi data packets,
determining an angle of arrival based on the CSI, and
displaying on a user interface a location of the rider device based on the determined angle of arrival.

10. The method of claim 9, wherein the step of displaying is performed at the driver device.

11. The method of claim 9, further comprising:
transmitting the determined angle of arrival from the driver device to a smartphone, and wherein the step of displaying is performed at the smartphone.

12. The method of claim 9, further comprising:
sending a signal to the rider device that includes data including the determined angle of arrival, and
displaying on a rider device user interface a location of the driver based on the data.

13. The method of claim 9, further comprising:
capturing an image of an environment,
executing an object-detection model based on image data from the image to detect one or more humans in the environment,
matching a location of a detected human within the environment with the angle of arrival to identify a rider,
displaying, on the user interface, the image of the environment, and
overlaying an indication on the displayed image of the environment that identifies the rider based on the matched location of the detected human with the angle of arrival.

14. The method of claim 9, wherein the step of determining the angle of arrival includes executing an angle of arrival (AoA) application to perform signal-processing of the extracted CSI.

15. The method of claim 9, wherein the step of determining the angle of arrival includes executing an angle of arrival (AoA) application that utilizes a pre-trained machine-learning model that correlates CSI information with estimated locations of devices.

16. A dashcam display for assisting drivers and riders to find each other in a ride-hailing environment, the dashcam display comprising:
one or more Wi-Fi antennas configured to receive Wi-Fi data packets from a rider's mobile device;
a wireless transceiver configured to communicate with a driver's mobile device;
a storage configured to maintain an angle of arrival (AoA) application that, when executed, determines an angle of arrival of an incoming Wi-Fi signal from the rider's mobile device; and
a processor coupled to the storage and the wireless transceiver, the processor programmed to:
receive Wi-Fi data packets from the rider's mobile device,
measure and extract channel state information (CSI) from the received Wi-Fi data packets,
execute the AoA application to determine the angle of arrival based on the CSI, and
cause the wireless transceiver to send a signal to the driver's mobile device to display a location of the rider based on the determined angle of arrival.

17. The dashcam display of claim 16, further comprising a camera configured to capture images of an environment external to the vehicle, wherein the processor is further programmed to:
utilize the camera to capture an image of an environment external to the vehicle,
execute an object-detection model based on image data from the image to detect one or more humans in the environment, and
matching a location of a detected human within the environment with the angle of arrival to identify the rider,
wherein the location of the rider displayed on the driver's mobile device is based on the matching.

18. The dashcam display of claim 17, wherein the processor is further programmed to:
send a signal to the driver's mobile device to cause the driver's mobile device to display the image of the environment captured by the camera, and
send a signal to the driver's mobile device to cause the driver's mobile device to overlaying an indication on the displayed image of the environment that identifies the rider based on the matching.

19. The dashcam display of claim 16, wherein the one or more Wi-Fi antennas is a plurality of antennas, and the AoA application uses, as input, a distance between the Wi-Fi antennas to determine the angle of arrival.

20. The dashcam display of claim 16, wherein the processor is further programmed to determine the location of the rider based on a pre-trained neural network-based classifier that operates models that compare how the CSI or angle of arrival differs for various locations of rider devices.
